(19) United States
(12) Patent Application Publication
(10) Pub. No.: US 2014/0340045 A1
(43) Pub. Date: Nov. 20, 2014

(54) APPARATUS FOR BATTERY STATE ESTIMATION

(71) Applicants: CALSONIC KANSEI CORPORATION, Saitama-shi, Saitama (JP); KEIO UNIVERSITY, Tokyo (JP)

(72) Inventors: Kinnosuke Itabashi, Saitama (JP); Shuichi Adachi, Kanagawa (JP)

(73) Assignees: CALSONIC KANSEI CORPORATION, Saitama (JP); KEIO UNIVERSITY, Tokyo (JP)

(21) Appl. No.: 14/359,692

(22) PCT Filed: Dec. 4, 2012
(86) PCT No.: PCT/JP2012/007761

§ 371 Date: May 21, 2014

(30) Foreign Application Priority Data
Jan. 26, 2012 (JP) 2012-013813

(51) Int. Cl. H02J 7/00

(52) U.S. Cl. CPC H02J 7/00
USPC 320/134

(57) ABSTRACT

An apparatus for battery state estimation can accurately estimate the internal state of a battery by taking into consideration the slow response portion of the battery. The apparatus for battery state estimation includes a charge/discharge current detection unit, a terminal voltage detection unit, an equivalent circuit model including a fast response portion and slow response portion of the battery, a sequential parameter estimation unit that performs sequential parameter estimation, using only the fast response portion among response portions, based on the charge/discharge current value and the terminal voltage value, a constant setting unit that sets a constant representing resistance and capacitance in the slow response portion of the equivalent circuit model, a plurality of multiplication units that multiply the parameter estimated by the sequential parameter estimation unit and the constant by the charge/discharge current value, and an addition unit that obtains an overvoltage value of the battery by adding the multiplied values.

### TECHNICAL FIELD

The present invention relates to an apparatus for battery state estimation that can accurately estimate the internal state of a battery.

### BACKGROUND ART

Among batteries, rechargeable secondary batteries are for example used in electric vehicles and the like. In this case, it is necessary to know the drivable distance with the battery, the current value at which charge and discharge are possible, and the like, yet to acquire knowledge thereof it is necessary to detect the battery's state of charge (SOC), state of health (SOH), and the like, which are internal state quantities of the battery. However, since these internal state quantities cannot be directly detected, a current integration method (also referred to as a coulomb counting method or a bookkeeping method) or an open circuit voltage estimation method (sequential parameter method) is often used. The current integration method estimates the internal state by detecting the charge/discharge current value over time. The open circuit voltage estimation method establishes a battery model, compares the input/output with an actual battery, estimates sequential parameters of the battery model while reducing the differences with an adaptive filter such as a Kalman filter, and estimates the open circuit voltage of the battery in order to estimate the state of charge.

While the current integration method excels at estimating the state of charge in a short time, it has disadvantages, including the accumulation of error, which does not reset easily, and the need for constant observation. On the other hand, while the sequential parameter method does not require constant observation in order to observe both input and output and does not accumulate error, it has the disadvantage of poor estimation accuracy of the state of charge in a short time.

Therefore, the state of charge is estimated with a combination of these two methods.

Patent Literature 1 discloses such a conventional technique.

Specifically, the apparatus for secondary battery state of charge estimation disclosed in Patent Literature 1 includes a first state of charge estimation unit that estimates a first state of charge by establishing a battery model and using an adaptive digital filter to perform sequential parameter estimation, a second state of charge estimation unit that estimates a second state of charge using a current integration method during a current state in which state of charge estimation using the adaptive digital filter is difficult, and a final state of charge estimated value selection unit that appropriately selects one of the first state of charge and the second state of charge. In this case, the final state of charge estimated value selection unit is configured to select the first state of charge when the sign of the current reverses and to select the second state of charge when, from that point in time, only charging or only discharging continues for at least a predetermined time set in advance.

### CITATION LIST

### Patent Literature

Patent Literature 1: JP2008-164417A

### SUMMARY OF INVENTION

The above conventional apparatus for state of charge estimation, however, has the problems described below.

Namely, when using a sequential parameter method, a battery equivalent circuit model represented by impedance at the battery interface, impedance in each electrolyte portion, and the like is used.

In this case, the battery has a fast response portion at the interface where the charge-transfer process takes place (with a time constant of, for example, several microseconds to several hundred milliseconds) and a slow response portion that becomes the diffusion process in the diffusion layer between the electrolyte interface and the bulk region (with a time constant of, for example, one second to several hours). Therefore, the battery equivalent circuit model uses a mathematical model that represents these portions.

In this case, for the fast response portion of the battery, a parameter representing the internal state of the battery can be estimated easily with the sequential parameter method from the perspective of the S/N ratio and of observability.

Conversely, for the slow response portion, the S/N ratio is small, and from the perspective of observability it is difficult to estimate the parameter accurately with the sequential parameter method.

In an environment in which the fast response portion of the battery is mainly used, such as a Hybrid Electric Vehicle (HEV), the overvoltage portion can be accurately calculated even when performing sequential parameter estimation. The open circuit voltage, and therefore the state of charge of the battery, can thus be accurately estimated.

By contrast, in an environment in which even the slow response portion of the battery is used, such as an Electric Vehicle (EV), when sequential parameter estimation is performed, the parameter estimation accuracy for the slow response portion of the battery worsens, and error ends up occurring in the overvoltage portion. As a result, a problem occurs in that the estimation accuracy for state quantities of the battery, such as the open circuit voltage and the state of charge, worsens.

In this case, in order to calculate the slow response portion of the battery, it is possible to input an arbitrary waveform, and if conditions such that the open circuit voltage of the battery can be calculated accurately are met, it is possible to perform parameter estimation of the slow portion of the battery accurately using, for example, the following method.

Specifically, in addition to measuring a terminal voltage value Vt(k) of the battery using an accurate voltage sensor, the discharge and charge currents entering and exiting the battery are measured using an accurate battery shunt resistor-type current sensor, and the state of charge SOC(k) is calculated using the coulomb counting method. Using a lookup table listing relational data, obtained in advance by experimental measurement, between the state of charge and the open circuit voltage, the open circuit voltage value OCV(k) corresponding to the state of charge SOC(k) is obtained. Next, with a subtractor, the open circuit voltage value OCV(k) is subtracted from the terminal voltage value Vt(k) to yield an overvoltage η(k).

Using the current as input and the overvoltage as output, an equivalent circuit model for the overvoltage portion is established. This equivalent circuit model for the overvoltage portion should be a mathematical model that represents the battery interior, e.g. a diffusion equation or the like such as a Foster-type equivalent circuit model.

It is thus possible, at first view, to perform parameter estimation of the slow response portion of the battery by experiment or the like. Considering the environment in which the battery is actually used, however, such as an EV, an arbitrary waveform is almost never input, and conditions or circumstances in which the open circuit voltage is difficult to determine accurately predominate.

Accordingly, in circumstances in which the battery is actually used, parameter estimation of the slow response portion of the battery is extremely difficult. As a result, a problem exists in that the internal state of the battery, such as the open circuit voltage and the state of charge of the battery, is difficult to estimate accurately.

The present invention has been conceived in light of the above problems, and it is an object thereof to provide an apparatus for battery state estimation that can accurately estimate the internal state of the battery by taking the slow response portion of the battery into consideration to improve the estimation accuracy of the battery overvoltage.

To achieve this object, an apparatus for battery state estimation according to the present invention as recited in claim 1 includes a charge/discharge current detection unit configured to detect a charge/discharge current value of a battery; a terminal voltage detection unit configured to detect a terminal voltage value of the battery; an equivalent circuit model including a fast response portion and a slow response portion of the battery; a sequential parameter estimation unit configured to perform sequential parameter estimation, using only the fast response portion among response portions of the equivalent circuit model, based on the charge/discharge current value input from the charge/discharge current detection unit and the terminal voltage value input from the terminal voltage detection unit; a constant setting unit configured to set a constant representing resistance and capacitance in the slow response portion of the equivalent circuit model; a first multiplication unit configured to obtain an overvoltage value of the fast response portion by multiplying a parameter estimated by the sequential parameter estimation unit by the charge/discharge current value; a second multiplication unit configured to obtain an overvoltage value of the slow response portion by multiplying the constant set by the constant setting unit by the charge/discharge current value; and an addition unit configured to obtain an overvoltage value of the battery by adding the overvoltage value of the fast response portion obtained by the first multiplication unit and the overvoltage value of the slow response portion obtained by the second multiplication unit.

The apparatus for battery state estimation as recited in claim 2 is the apparatus as recited in claim 1, further including a subtraction unit configured to obtain an open circuit voltage value of the battery by subtracting the overvoltage value obtained by the addition unit from the terminal voltage value obtained by the terminal voltage detection unit; and an open circuit voltage/state of charge estimation unit configured to determine a state of charge of the battery based on the open circuit voltage obtained by the subtraction unit.

The apparatus for battery state estimation as recited in claim 3 is the apparatus as recited in claim 1 or 2, further including a filter processing unit configured to input the terminal voltage value obtained by the terminal voltage detection unit into the sequential parameter estimation unit by removing a part of the terminal voltage value corresponding to the slow response portion.

The apparatus for battery state estimation as recited in claim 4 is the apparatus as recited in claim 3, such that the filter processing unit is further configured to input the charge/discharge current value obtained by the charge/discharge current detection unit into the sequential parameter estimation unit by removing a part of the charge/discharge current value corresponding to the slow response portion.

According to the apparatus for battery state estimation as recited in claim 1, sequential parameter estimation is performed only with the fast response portion within the battery equivalent circuit model, and using a constant determined in advance by experiment for the slow response portion of the battery, a parameter and the constant are multiplied by the charge/discharge current value and added in order to improve estimation accuracy of the battery overvoltage. As a result, the internal state of the battery can be estimated accurately.

According to the apparatus for battery state estimation as recited in claim 2, the overvoltage value is subtracted from the terminal voltage value to obtain an accurate open circuit voltage value of the battery, and using this open circuit voltage value, the corresponding state of charge is determined. Therefore, the state of charge, which is an internal state of the battery, can also be estimated accurately.

According to the apparatus for battery state estimation as recited in claim 3, a filter processing unit is provided and inputs the terminal voltage value into the sequential parameter estimation unit by removing a part of the terminal voltage value corresponding to the slow response portion. Therefore, redundant calculation of the overvoltage value in the slow response portion and the fast response portion based on the terminal voltage value can easily and reliably be removed.

According to the apparatus for battery state estimation as recited in claim 4, the filter processing unit inputs the charge/discharge current value into the sequential parameter estimation unit by removing a part of the charge/discharge current value corresponding to the slow response portion. Therefore, calculation of this part is made easy during sequential parameter estimation.

### BRIEF DESCRIPTION OF DRAWINGS

The present invention will be further described below with reference to the accompanying drawings, wherein:

FIG. 1 is a block diagram illustrating the relationships in a functional block representing an apparatus for battery state estimation, connected to an actual battery, according to Embodiment 1 of the present invention;

FIG. 2 illustrates a battery equivalent circuit model for the fast response portion and the slow response portion of a battery used in the sequential parameter estimation unit of FIG. 1;

FIG. 3 illustrates the structure of the low pass filter constituting the filter processing unit used in the apparatus for battery state estimation of FIG. 1;

FIG. 4 is a block diagram illustrating the relationships in a functional block representing an apparatus for battery state estimation, connected to an actual battery, according to Embodiment 2 of the present invention;

FIG. 5 illustrates the sampling method for separating the fast response portion from the slow response portion of the battery in the battery equivalent circuit model used in the apparatus for battery state estimation according to Embodiment 2; and

FIG. 6 is a Bode plot used in an example of determining the border between the fast response portion and the slow response portion of the battery used in the sampling method of FIG. 5.

### DESCRIPTION OF EMBODIMENTS

The following describes the present invention in detail based on the embodiments illustrated in the attached drawings.

### Embodiment 1

First, the overall structure of the apparatus for battery state estimation according to Embodiment 1 is described.

The apparatus for battery state estimation according to Embodiment 1 is, for example, installed in an electric vehicle and connected to an actual battery 1 (secondary battery such as a lithium-ion battery) that can provide power to a non-illustrated drive motor or the like. This apparatus for state estimation includes a current sensor 2, a voltage sensor 3, a filter processing unit 4, a sequential parameter estimation unit 5, a first multiplier 6, a second multiplier 7, an adder 8, a subtractor 9, an open circuit voltage/state of charge conversion unit 10, and a constant setting unit 11.

The current sensor 2 detects the magnitude of discharge current when power is being provided from the actual battery 1 to the drive motor or the like. The current sensor 2 also detects the magnitude of charge current when an electric motor is caused to function as an electrical generator during vehicle braking to collect a portion of the braking energy or during charging by a ground-based power supply system. The charge/discharge current value Ia that is detected is output to the filter processing unit 4 and the second multiplier 7 as an input signal that is positive during charging and negative during discharging.

Note that the current sensor 2 may adopt any of a variety of structures and forms and corresponds to the charge/discharge current detection unit of the present invention.

The voltage sensor 3 detects the voltage value between terminals of the actual battery 1. The detected terminal voltage value Va is output to the filter processing unit 4 and the subtractor 9.

Note that the voltage sensor 3 may adopt any of a variety of structures and forms and corresponds to the terminal voltage detection unit of the present invention.

The charge/discharge current value Ia from the current sensor 2, the terminal voltage value Va from the voltage sensor 3, and a constant from the constant setting unit 11 are input into the filter processing unit 4. The filter processing unit 4 removes the slow response portion (diffusion resistance) from each of the charge/discharge current value Ia and the terminal voltage value Va and inputs the resulting fast response portion (connection resistance+electrolyte resistance+charge transfer resistance) as a filter processed current value Ib and a filter processed voltage value Vb into the sequential parameter estimation unit 5. The filter processing unit 4 is described below in detail.

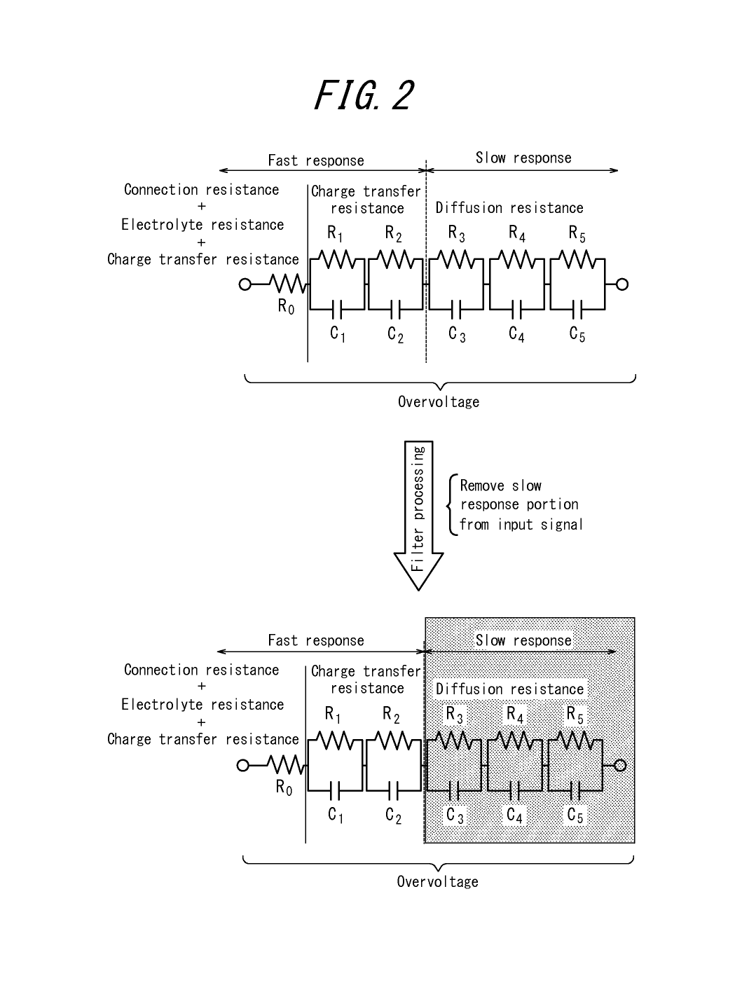

The sequential parameter estimation unit 5 estimates, within the battery equivalent circuit model illustrated in FIG. 2, parameters for the fast response portion yielded by removing the slow response portion. In FIG. 2, the portion corresponding to the third through fifth resistor-capacitor parallel circuits R₃ and C₃, R₄ and C₄, R₅ and C₅ (the shaded portion in FIG. 2) represents the slow response portion, and the portion corresponding to R₀ and the first and second resistor-capacitor parallel circuits R₁ and C₁, R₂ and C₂ represents the fast response portion. In greater detail, the sequential parameter estimation unit 5 takes the filter processed current value Ib and the filter processed voltage value Vb obtained from the filter processing unit 4 as input signals and compares the output value of the actual battery 1 with the fast response portion of the battery equivalent circuit model using, for example, a Kalman filter. The sequential parameter estimation unit 5 sequentially adjusts the parameters for the equation of state in the above model so that the difference in these output values is reduced, thereby estimating the parameters for the fast response portion. Details on parameter estimation with a Kalman filter are described in JP2011-007874A by the present applicant.

The resistance values (R₀, R₁, R₂) and capacitances (C₁, C₂), which are the parameters estimated by the sequential parameter estimation unit 5, are output to the first multiplier 6.

The first multiplier 6 multiplies the charge/discharge current value

Ia detected by the current sensor 2 by the resistance values (R₀, R₁, R₂) and the capacitances (C₁, C₂) estimated by the sequential parameter estimation unit 5 to obtain a first overvoltage value V₀₁. This first overvoltage value V₀₁ is output to the adder 8.

Note that the first multiplier 6 corresponds to the first multiplication unit of the present invention.

The second multiplier 7 multiplies the constant obtained from the constant setting unit 11 by the charge/discharge current value Ia obtained from the current sensor 2 to obtain a second overvoltage value V₀₂ for the slow portion of the battery. The second multiplier 7 then outputs this second overvoltage value V₀₂ to the adder 8.

Note that the second multiplier 7 corresponds to the second multiplication unit of the present invention.

The adder 8 adds the first overvoltage value V₀₁ for the fast response portion of the battery obtained by the first multiplier 6 and the second overvoltage value V₀₂ for the slow response portion of the battery obtained by the second multiplier 7 to obtain a battery overvoltage value V₀. The adder 8 then outputs this overvoltage value V₀ to the subtractor 9.

Note that the adder 8 corresponds to the addition unit of the present invention.

The subtractor 9 subtracts the overvoltage value V₀ obtained by the adder 8 from the terminal voltage value Va detected by the voltage sensor 3 to obtain an open circuit voltage OCV of the battery. The subtractor 9 then outputs this open circuit voltage value OCV to the open circuit voltage/state of charge conversion unit 10.

Note that the subtractor 9 corresponds to the subtraction unit of the present invention.

The open circuit voltage/state of charge conversion unit 10 stores data representing the relationship between the open circuit voltage and the state of charge obtained in advance by experiment as a lookup table, takes the open circuit voltage value OCV obtained by the subtractor 9 as input, and outputs a corresponding state of charge SOC_{OCV}.

Note that the open circuit voltage/state of charge conversion unit 10 corresponds to the open circuit voltage/state of charge estimation unit of the present invention.

The constant setting unit 11 sets a constant as a characteristic value representing the slow response portion within the equivalent circuit model of the actual battery 1 and outputs this constant to the filter processing unit 4 and the second multiplier 7. This characteristic value, i.e. constant, is characteristic of the actual battery 1 and is determined by experiment.

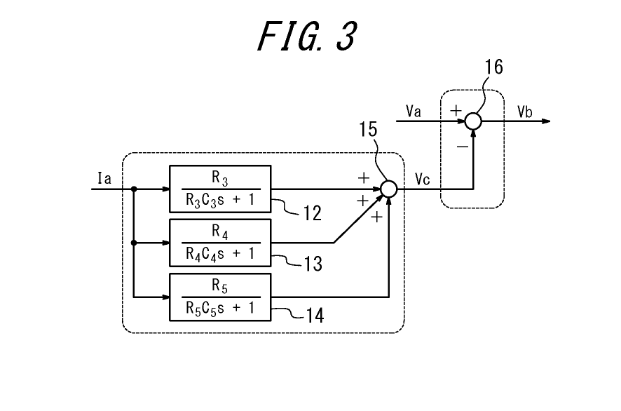

Next, with reference to FIGS. 2 and 3, the filter processing unit 4 is described in greater detail.

In order to be able to perform parameter estimation so that the sequential parameter estimation unit 5 does not perform redundant calculation of the overvoltage portion between the fast response portion (connection resistance+electrolyte resistance+charge transfer resistance) and the slow response portion (diffusion resistance) of the battery, the filter processing unit 4 performs filtering on the charge/discharge current value Ia and the terminal voltage value Va.

In the present embodiment, before parameter estimation is performed by the sequential parameter estimation unit 5, filter processing is performed on the charge/discharge current value Ia and the terminal voltage value Va using a value (constant) determined in advance by experiment. As illustrated in FIG. 2, in the present embodiment, parameter estimation of the fast response portion is performed using a signal resulting from removing the slow response portion from the input signal to avoid redundancy of the overvoltage in the fast response portion and the overvoltage in the slow response portion.

In the present embodiment, the low pass filter illustrated in FIG. 3, for example, is used for the terminal voltage value Va.

In FIG. 3, the low pass filter subtracts a voltage value Vc for the slow response portion, obtained by calculation using the charge/discharge current value Ia, from the terminal voltage value Va so as to calculate the filter processed voltage value Vb, which is the voltage value for the fast response portion. The low pass filter thus removes the voltage portion for the slow response portion.

In FIG. 3, the charge/discharge current value Ia is input into a transfer function 12 corresponding to the third circuit R₃, C₃, a transfer function 13 corresponding to the fourth circuit R₄, C₄ , and a transfer function 14 corresponding to the fifth circuit R₅, C₅ in the equivalent circuit model of the slow response portion of the battery, and the respective overvoltage values are obtained. These overvoltage values are added in an adder 15 to obtain a voltage value Vc of the slow response portion. Note that “s” in FIG. 3 is a Laplace transform variable.

A subtractor 16 subtracts the voltage value Vc of the slow response portion from the terminal voltage value Va to obtain the voltage value Vb of the fast response portion.

On the other hand, with regard to current, the filter processing unit 4 removes the slow response portion using a high pass filter and inputs the result as the filter processed current value Ib into the sequential parameter estimation unit 5, yet the current may be input as is into the sequential parameter estimation unit 5 without processing by the filter processing unit 4.

Next, operations of the apparatus for battery state estimation according to Embodiment 1 with the above structure are described.

The current sensor 2 detects the charge/discharge current value Ia that is being charged or discharged in the actual battery 1 and inputs this value into the filter processing unit 4 and the second multiplier 7.

On the other hand, the voltage sensor 3 detects the terminal voltage value Va in the actual battery 1 and inputs this value into the filter processing unit 4 and the subtractor 9.

Using a constant from the constant setting unit 11, the filter processing unit 4 removes the slow response portion of the battery from the charge/discharge current value Ia and the terminal voltage value Va and inputs the resulting filter processed current value Ib and filter processed voltage value Vb into the sequential parameter estimation unit 5.

Based on the filter processed current value Ib and filter processed voltage value Vb that are input, the sequential parameter estimation unit 5 uses the equivalent circuit model for the fast response portion of the battery in FIG. 2 (the resistor R₀ and the first and second resistor-capacitor parallel circuits (R₁ and C₁, R₂ and C₂) in FIG. 2) and a Kalman filter to estimate the resistance values (R₀, R₁, R₂) and capacitances (C₁, C₂), which are the parameters for the fast response portion. These resistance values and capacitances are input into the first multiplier 6 and multiplied by the charge/discharge current value Ia input from the current sensor 2 to obtain the first overvoltage value V₀₁. This first overvoltage value V₀₁ is input into the adder 8.

On the other hand, a constant representing the resistance value and capacitance of the slow portion of the battery is input into the second multiplier 7 from the constant setting unit 11, and this constant is multiplied by the charge/discharge current value Ia input from the current sensor 2 to obtain the second overvoltage value V₀₂ of the slow response portion of the battery. This second overvoltage value V₀₂ is input into the adder 8.

In the adder 8, the first overvoltage value V₀₁ input from the first multiplier 6 and the second overvoltage value V₀₂ input from the second multiplier 7 are added to obtain the battery overvoltage value V₀. This overvoltage value V₀ is input into the subtractor 9.

In the subtractor 9, the overvoltage value V₀ input from the adder 8 is subtracted from the terminal voltage value Va input from the voltage sensor 3 to obtain the open circuit voltage OCV of the battery. This open circuit voltage OCV is input into the open circuit voltage/state of charge conversion unit 10.

Using an open circuit voltage/state of charge lookup table, the open circuit voltage/state of charge conversion unit 10 obtains the state of charge SOC_{OCV} corresponding to the input open circuit voltage value OCV. The open circuit voltage/state of charge conversion unit 10 then outputs this state of charge SOC_{OCV} to necessary calculation units, such as a drivable distance calculation unit (not illustrated).

As is clear from the above description, the apparatus for battery state estimation according to Embodiment 1 has the following effects.

Using the filter processed current value Ib and the filter processed voltage value Vb, from which the slow response portion is removed in the filter processing unit 4, the apparatus for battery state estimation according to Embodiment 1 performs sequential parameter estimation using an equivalent circuit model for the fast response portion of the battery. The apparatus for state estimation then multiplies the parameters (resistance value and capacitor of the fast response portion) obtained by sequential parameter estimation by the charge/discharge current value Ia to obtain the first overvoltage value V₀₁. Regarding the slow response portion of the battery, the apparatus for state estimation multiplies a constant determined in advance by experiment (characteristic value of the battery) by the charge/discharge current value Ia to obtain the second overvoltage value V₀₂. By adding the first overvoltage value V₀₁ and the second overvoltage value V₀₂, the battery overvoltage value V₀ can be obtained accurately and easily. Accordingly, in the actual usage environment of the battery, even the slow response portion of the battery, for which a sequential parameter method is difficult, is taken into consideration to allow for accurate estimation of the internal state of the battery.

With regards to the state of charge of the battery, the apparatus for state estimation determines the open circuit voltage value OCV by subtracting the overvoltage value V₀ from the terminal voltage value Va and using open circuit voltage/state of charge relational data to obtain the state of charge SOC_{OCV} corresponding to the open circuit voltage value OCV. Therefore, the state of charge can be obtained accurately with a simple calculation.

Accordingly, it is possible to prevent redundant calculation of the overvoltage value of the fast response portion and the overvoltage value of the slow response portion of the battery.

### Embodiment 2

Next, Embodiment 2 is described. In the description of Embodiment 2, structural components similar to Embodiment 1 are not illustrated or are labeled with the same reference signs, and a description thereof is omitted. Only the differences are described.

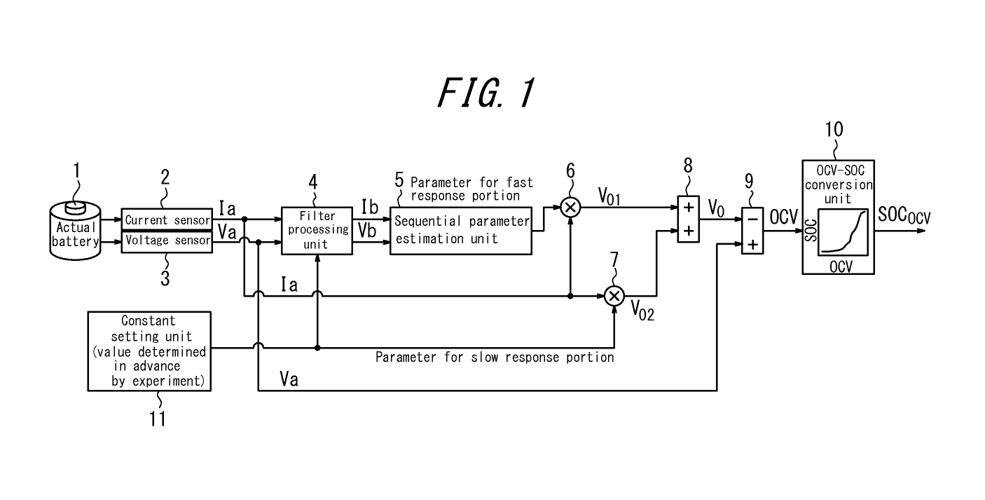

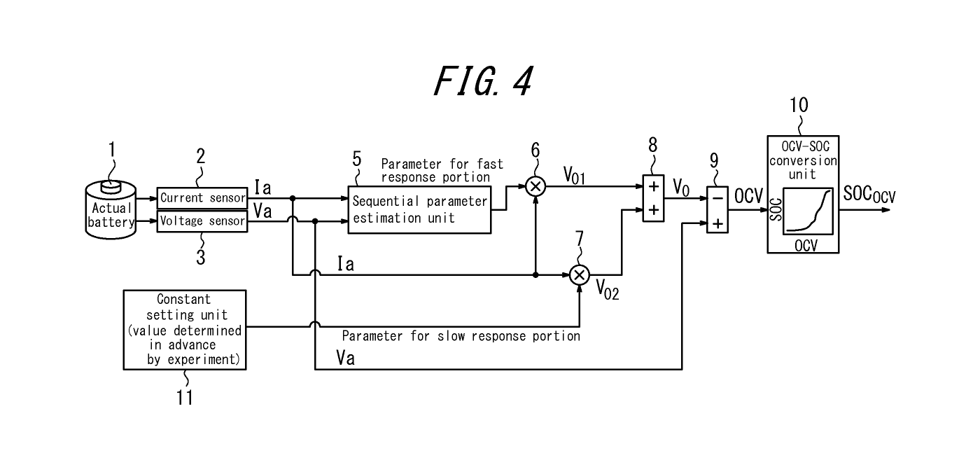

As illustrated in FIG. 4, the apparatus for battery internal state estimation according to Embodiment 2 differs from Embodiment 1 in that the filter processing unit 4 of Embodiment 1 in FIG. 1 has been removed. The remaining structure is similar to Embodiment 1.

The apparatus for battery state estimation according to Embodiment 2 does not include a filter processing unit that removes the overvoltage portion of the slow response portion of the battery, like the low pass filter of Embodiment 1. Therefore, for parameter estimation in the sequential parameter estimation unit 5, a different means is necessary for preventing redundant calculation of the overvoltage value in the slow response portion of the battery.

Therefore, in Embodiment 2, the sequential parameter estimation unit 5 is provided with a filter processing function to change the sampling period and separate the fast response portion from the slow response portion of the battery.

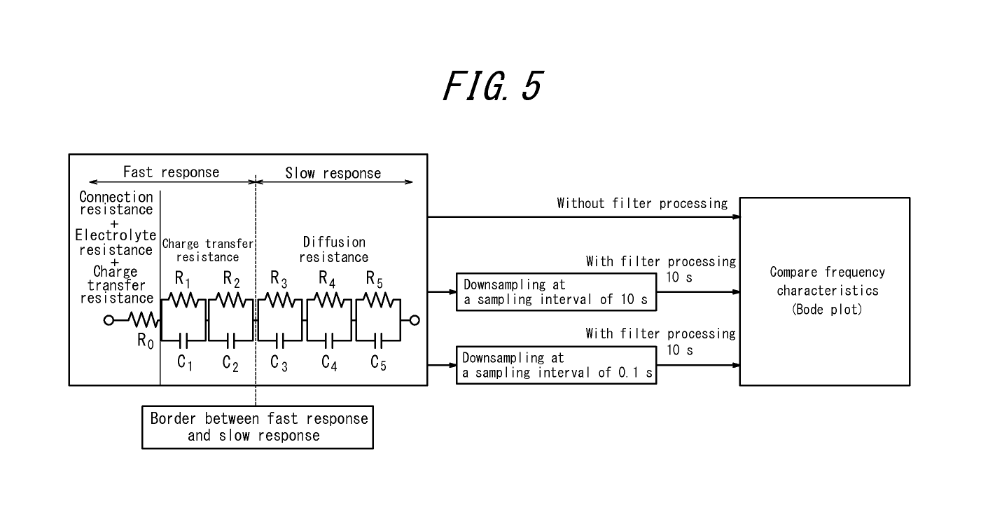

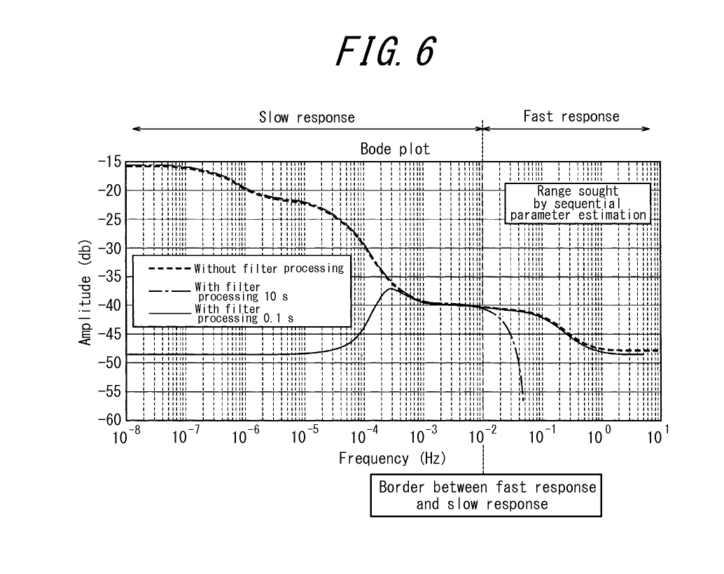

Specifically, in the present embodiment, as illustrated in FIG. 5, when the sequential parameter estimation unit 5 performs parameter estimation at different sampling frequencies (10 s and 0.1 s) for the battery equivalent circuit model of overvoltage, the frequency range of the obtained parameter was examined. FIG. 6 shows the resulting Bode plot.

The Bode plot in FIG. 6 (horizontal axis: frequency (Hz), vertical axis: amplitude (dB)) shows the system identification results, with the dashed line representing the case of no filter processing by sampling period modification being performed on the charge/discharge current value Ia detected by the current sensor 2 and the terminal voltage value Va obtained by the voltage sensor 3, the alternate long and short dash line representing the case of performing filter processing by sampling period modification (downsampling at a sampling interval of 10 s) on the charge/discharge current value Ia and the terminal voltage value Va, and the solid line representing the case of performing similar filter processing (downsampling at a sampling interval of 0.1 s).

As is clear from FIG. 6, the experiment to perform sequential parameter estimation with a sampling frequency of 10 s shows matching results for the range of the slow response portion. However, when sequential parameter estimation is actually performed with a sampling frequency of 10 s, in the slow response portion of the battery, the S/N ratio is small, and from the perspective of observability it is difficult to perform sequential parameter estimation.

On the other hand, it is clear that when performing sequential parameter estimation with a sampling frequency of 0.1 s, while the results match in the fast response portion of the battery, the results do not match in the slow response portion of the battery.

In other words, in the range of the fast response portion of the battery, unlike the slow response portion of the battery, sequential parameter estimation can easily be performed from the perspective of the S/N ratio and of observability. Therefore, by setting the sampling frequency to 0.1 s and performing sequential parameter estimation, it is possible to calculate the parameter for only the fast response portion. As a result, by using these parameters, it is possible to calculate the overvoltage in only the fast response portion.

Note that the sampling period can be determined by the border between the fast response portion and the slow response portion of the battery. This border can be assumed to vary depending on the usage conditions of the battery, such as the state of charge, the discharge current, the state of health, and the like, and for the slow response portion, a predetermined value is used as illustrated in FIG. 4.

In this way, the apparatus for battery state estimation according to Embodiment 2 separates the fast response portion from the slow response portion by changing the sampling frequency in the sequential parameter estimation. Hence, Embodiment 2 has similar effects to Embodiment 1, such as allowing for accurate estimation of the internal state of a battery by preventing redundancy of the overvoltage between the two portions.

The present invention has been described based on the above embodiments, yet the present invention is not limited to these embodiments and includes any design modification or the like within the spirit and scope of the present invention.

For example, the low pass filter and high pass filter used in the filter processing unit 4 are not limited to those of the embodiment, and a variety of alternatives may be used.

The battery equivalent circuit model is not limited to a Foster-type model, and any other mathematical model that represents the battery interior, such as a diffusion equation or the like, may be used.

Furthermore, the apparatus for battery state estimation of the present invention is not limited to use in a vehicle such as an electric vehicle and may be used in any apparatus that infers the internal state of a secondary battery.

### REFERENCE SIGNS LIST

1: Actual battery

2: Current sensor (charge/discharge current detection unit)

3: Voltage sensor (terminal voltage detection unit)

4: Filter processing unit

5: Sequential parameter estimation unit

6: First multiplier (first multiplication unit)

7: Second multiplier (second multiplication unit)

8: Adder (addition unit)

9: Subtractor (subtraction unit)

10: Open circuit voltage/state of charge conversion unit (open circuit voltage/state of charge estimation unit)

11: Constant setting unit

12, 13, 14: Transfer function

15: Adder

16: Subtractor

1. An apparatus for battery state estimation comprising:
a charge/discharge current detection unit configured to detect a charge/discharge current value of a battery;
a terminal voltage detection unit configured to detect a terminal voltage value of the battery;
an equivalent circuit model including a fast response portion and a slow response portion of the battery;
a sequential parameter estimation unit configured to perform sequential parameter estimation, using only the fast response portion among response portions of the equivalent circuit model, based on the charge/discharge current value input from the charge/discharge current detection unit and the terminal voltage value input from the terminal voltage detection unit;
a constant setting unit configured to set a constant representing resistance and capacitance in the slow response portion of the equivalent circuit model;
a first multiplication unit configured to obtain an overvoltage value of the fast response portion by multiplying a parameter estimated by the sequential parameter estimation unit by the charge/discharge current value;
a second multiplication unit configured to obtain an overvoltage value of the slow response portion by multiplying the constant set by the constant setting unit by the charge/discharge current value; and
an addition unit configured to obtain an overvoltage value of the battery by adding the overvoltage value of the fast response portion obtained by the first multiplication unit and the overvoltage value of the slow response portion obtained by the second multiplication unit.

2. The apparatus according to claim 1, further comprising:
a subtraction unit configured to obtain an open circuit voltage value of the battery by subtracting the overvoltage value obtained by the addition unit from the terminal voltage value obtained by the terminal voltage detection unit; and
an open circuit voltage/state of charge estimation unit configured to determine a state of charge of the battery based on the open circuit voltage obtained by the subtraction unit.

3. The apparatus according to claim 1, further comprising:
a filter processing unit configured to input the terminal voltage value obtained by the terminal voltage detection unit into the sequential parameter estimation unit by removing a part of the terminal voltage value corresponding to the slow response portion.

4. The apparatus according to claim 3, wherein
the filter processing unit is further configured to input the charge/discharge current value obtained by the charge/discharge current detection unit into the sequential parameter estimation unit by removing a part of the charge/discharge current value corresponding to the slow response portion.

5. The apparatus according to claim 2, further comprising:
a filter processing unit configured to input the terminal voltage value obtained by the terminal voltage detection unit into the sequential parameter estimation unit by removing a part of the terminal voltage value corresponding to the slow response portion.

6. The apparatus according to claim 4, wherein
the filter processing unit is further configured to input the charge/discharge current value obtained by the charge/discharge current detection unit into the sequential parameter estimation unit by removing a part of the charge/discharge current value corresponding to the slow response portion.
